(19) United States
(12) Patent Application Publication
(10) Pub. No.: US 2023/0017703 A1
(43) Pub. Date: Jan. 19, 2023

(54) LEVEL MEASURING DEVICE FOR MONITORING THE SURFACE TOPOLOGY OF A BULK MATERIAL

(71) Applicant: VEGA Grieshaber KG, Wolfach (DE)

(72) Inventor: Florian BURGERT, Gengenbach (DE)

(21) Appl. No.: 17/835,763

(22) Filed: Jun. 8, 2022

(30) Foreign Application Priority Data
Jun. 10, 2021 (EP) 21 178 836.9

(51) Int. Cl. G01S 15/04; G01F 23/284; G01S 13/88

(52) U.S. Cl. CPC G01S 15/04; G01F 23/284; G01S 13/88

(57) ABSTRACT

A level measuring device is provided. The level measuring device can be configured to monitor the surface topology of a bulk material, and can include a sensor unit for scanning several areas of the bulk material surface and an evaluation unit for calculating the volumes under these areas.

### CROSS-REFERENCE TO RELATED APPLICATIONS

This application claims priority to European Patent Application No. 21 178 836.9 filed on Jun. 10, 2021 the entire disclosure of which is incorporated herein by reference thereto.

### FIELD

The invention relates to a level measuring device for monitoring the surface topology of a bulk material, an external control and evaluation unit for such a level meter, a method for monitoring the surface topology of a bulk material, a program element, and a computer-readable medium.

### TECHNICAL BACKGROUND

Bulk materials are stored in silos or on dumps. The silos have one or more inlets through which they can be filled and one or more outlets to empty the silo. During both filling and emptying, there will usually be irregularities in the surface of the bulk material, typically in the form of bulk cones or discharge funnels.

If the volume of the bulk material stored in the silo is to be determined, it is advisable to scan the bulk material surface in order to determine the topology of the surface and from this to determine the volume with sufficient accuracy. The topology measurement data can be transmitted to an external control and evaluation unit, which performs the volume calculation and controls the filling and emptying processes of the silo.

### SUMMARY

There may be a desire to provide for an alternative level measuring device arranged to efficiently monitor the surface topology of a bulk material.

This desire is met by the subject-matter of the independent patent claims. Further embodiments result from the dependent claims and the following description.

A first aspect of the present disclosure relates to a level measurement device configured to monitor the surface topology of a bulk material or liquid. It comprises a sensor unit adapted to scan a first region of the surface of the bulk material, and to scan a second region of the surface of the bulk material.

An evaluation unit is further provided, which is configured to calculate a first volume and/or a first mass and/or a first average filling height of that part of the bulk material which is located below the first region of the surface of the bulk material, and a second volume and/or a first mass and/or a second average filling height of another part of the bulk material which is namely located below the second region of the surface of the bulk material.

The terms “sensor unit” and “evaluation unit” are to be interpreted broadly.

The level measuring device can be, for example, a level wheel arm measuring device, and in particular a level wheel arm measuring device that can scan the entire surface of the bulk material. In principle, it can also be a measuring device based on another technology, for example an optical measuring device or an ultrasonic measuring device. What is essential is the ability of the device to scan individual predeterminable areas of the bulk material surface one after the other.

The level measuring device thus enables profile detection, for example by means of radar technology, as a substitute for single-point measurements. In this way, it can be avoided that an uneven formation of the surface of the bulk material, which can occur during filling or emptying, does not falsify the measurement result.

In particular, the level measuring device can be equipped with two-wire technology, e.g., set up for connection to a 4 to 20 mA HART interface, for example. In this case, the amount of data that can be sent from the level measuring device is severely limited. By dividing the surface of the bulk material into areas, or segments, and calculating the underlying volume and/or average level for each area of the surface, the amount of data to be transmitted to an external control and evaluation unit can be effectively reduced.

According to a further embodiment, the sensor unit is arranged to scan the first area with a first resolution and to scan the second area with a second resolution that is lower than the first resolution.

Thus, energy and computing power can be saved during measurement and subsequent data evaluation, since certain areas of the bulk material surface that have not changed or have hardly changed compared to the previous measurement, for example, can be scanned with lower resolution than areas where a large change has occurred or is to be expected.

According to another embodiment, the first area has a different size than the second area. For example, it is larger.

According to another embodiment, the first region has a different shape than the second region.

The level measuring device can be configured to be self-learning and observe under which circumstances which areas of the bulk material surface change greatly and which areas change less or not at all. An example of this is the formation of a discharge funnel, where the annular area around the funnel does not change. So if the formation of a haul-off funnel occurs, the first area can be selected to be circular and the second area can be selected to be annular around the first area. The resolution of the scanning in the second area may be lower than that in the first area. In particular, the level measuring device may be arranged to change the size and shape of the different areas on a regular basis.

Other examples in which size and shape can be adjusted:
In a silo such as shown in FIG. 3A, one process can be connected to 1-3 outlets. Another process is connected to the remaining outlet. This results in different used areas in the silo. Depending on which outlets are currently used, the measurement is only performed in the area with high dynamics with high sampling.
Conversely, for example, the feeding can also take place via several filling strands. Depending on which line is filled, the area that is monitored is adjusted.

A silo can also be mobile, e.g. for transporting building materials to construction sites. During transport, the silo is horizontal. After installation, the filling material forms a sloping plane. The sensor must monitor the entire area. When the silo is filled again at the construction site, a classic cone of repose is formed. The area monitoring adapts to the new topology and detects the dynamics of the filling cone.

According to a further embodiment, the level measuring device has a communication unit that is set up to transmit the calculated volumes or the calculated fill levels to an external control and evaluation unit.

According to an embodiment, the calculation of a (total) topology is not carried out by the level measuring device, but, for each area, the calculation of the volume, the mass or the average filling height to be found there. This is different from the calculation of an overall topology, it may also require less computational effort and the amount of data of the result may be much smaller. This may be considered as a gist of the present invention.

According to a further embodiment, the communication unit is configured to transmit only a subset of the calculated volumes or fill levels during a data transmission to the external control and evaluation unit.

For example, the communication unit is configured to transmit a calculated volume or a calculated fill level to the external control and evaluation unit only if the volume or fill level has changed compared to the previous calculation or has changed more than a predetermined threshold value.

According to a further embodiment, the level measuring device is configured to connect to a 4 to 20 mA two-wire interface and/or for radio transmission of the calculated volumes or fill levels.

According to a further embodiment, the position of the first region is above an outlet or below an inlet of the container in which the bulk material is located. Likewise, the position of the second area may also be above an outlet or below an inlet.

Another aspect of the present disclosure relates to an external control and evaluation unit for a level measuring device, which is set up to visualize the volumes or fill levels transmitted by the level measuring device.

Another aspect of the present disclosure relates to the use of an external control and evaluation unit for a level measuring device described above and below, for visualizing the volumes or fill levels transmitted by the level measuring device.

Another aspect of the present disclosure relates to a method of monitoring the surface topology of a bulk material, wherein a first region of the surface of the bulk material and a second region of the surface of the bulk material are scanned, whereupon a first volume and/or a first average fill level of the bulk material located below the first region of the surface of the bulk material is calculated. Likewise, a second volume and/or a second average fill level of the bulk material located below the second region of the surface of the bulk material is calculated.

According to a further embodiment, the calculated volumes and/or fill levels are then transmitted to an external control and evaluation unit.

According to a further embodiment, the volumes and/or fill levels transmitted by the level measuring device are then visualized on the external control and evaluation unit.

Another aspect of the present disclosure relates to a program element which, when executed on a system for monitoring the surface topology of a bulk material, instructs the system (comprising the level measuring device described above and below and the control and evaluation unit described above and below) to perform the steps described above.

Another aspect of the present disclosure relates to a computer-readable medium on which the program element described above is stored.

Further embodiments are described below with reference to the figures. The representations in the figures are schematic and not to scale. If the same reference signs are used in the description of the figures, these designate the same or similar elements.

### BRIEF DESCRIPTION OF THE FIGURES

FIG. 1 shows a silo with a level measuring device according to one embodiment.

FIG. 2 shows a system for monitoring the surface topology of a bulk material according to one embodiment.

FIG. 3A shows a schematic view of a silo from above.

FIG. 3B shows a bulk material surface divided into nine areas.

FIG. 3C shows a round bulk material surface divided into three circular segments.

FIG. 4A shows nine areas to be scanned in a silo.

FIG. 4B shows two areas to be scanned in a silo.

FIG. 4C shows four areas to be scanned in a silo.

FIG. 5 shows the visualization of the measured volumes or average fill heights according to one embodiment.

FIG. 6 shows a flow diagram of a process according to one embodiment.

### DETAILED DESCRIPTION OF EMBODIMENTS

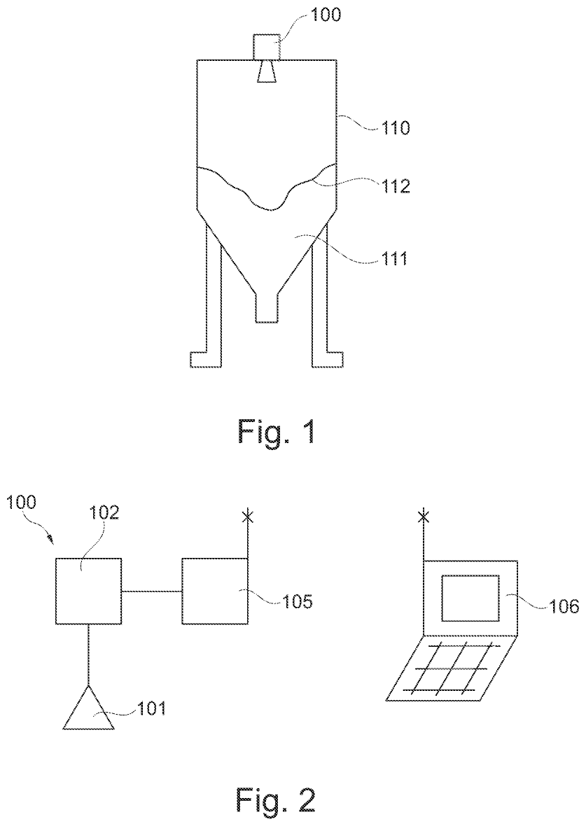

FIG. 1 shows a container 110 in the form of a silo in which a bulk material 111 is located. The bulk material 111 has a surface 112, which will normally be irregular.

A level measuring device 100, such as a level radar device, is disposed in the upper portion of the silo 110 and is capable of scanning the surface 112 of the bulk material 111.

The level measuring device 100 is set up for targeted profile monitoring of the bulk material 111 as well as for reduced data transmission. The small amount of data can be achieved by not recording the entire surface profile in the silo with a high resolution (similar to an image), but by dividing the silo into areas and using only these areas for evaluation and visualization. The level measuring device uses its internal raw data to determine the actual loading of the segment for each area, rather than the profile. This greatly reduces the amount of data to be transmitted. The sum of all areas then gives the total volume.

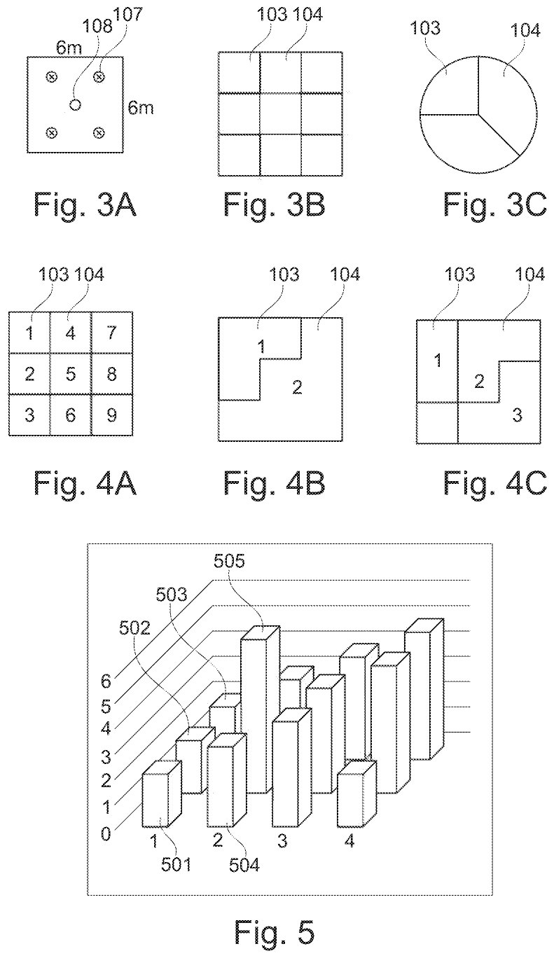

The division of the silo into the different areas depends on the silo itself and the customer's requirements for accuracy. Depending on the size of the silo and the available inlets and outlets, the division of the areas can have different characteristics. Examples of this are shown in FIGS. 3A to 3C.

FIG. 3A schematically shows a silo viewed from above, which has four outlets 107 and one inlet 108. Typical dimensions for such a silo are 6 m×6 m.

The customer now has the option of freely selecting the division of the areas to be scanned.

In the example of FIG. 3B, the silo is divided into nine areas. The first area 103 is located in one corner of the silo and the second area 104 is located next to it. For example, all nine areas have the same floor plan and size, such as a square shape with an edge length of 2 meters.

FIG. 3C shows another example of the division of the areas to be scanned using the example of a round silo. Here, the areas are in the form of circle sections or circle segments.

The areas in the silo can be contiguous or also assume different geometries, as can be seen in FIGS. 4A to 4C. For example, the areas can be square or rectangular and all have the same size (see FIG. 4A). However, they can also have very different sizes, as can be seen in FIGS. 4B and 4C. They can also have different shapes.

In the example of FIG. 4B, the customer can see whether first area 103 has already been emptied and whether material is still present in second area 104. Thus, filling can be started if only first area 103 is empty. A single-point measurement that only monitors second area 104 would result in an operational failure in first area 103 because the area of the silo is empty.

In the opposite case, the single-point measurement in first area 103 can report an empty silo, although material is still present in second area 104. This can lead to overfilling of the silo or to batch mixing in the case of sensitive media such as foodstuffs.

The visualization of the calculated volumes or filling heights of the bulk material in the operating tool of the external control and evaluation unit can be realized as shown in FIG. 5. This is exemplary for rectangular segments. However, the visualization can also be done by circular segments or other shapes.

To realize the visualization, the calculated data can be transmitted to the external control and evaluation unit via the HART protocol. For this purpose, the analog value is available on the one hand and four other variables on the other. Thus, the total volume can be transmitted cyclically together with the calculated volume data or average fill levels of four areas. The calculated data of the other areas can be transmitted via acyclic communication using the HART protocol.

Data compression is particularly useful for acyclic communication. Thus, a new measured value is only transmitted for a segment if the measured value has undergone a change.

For the customer, this process has two main benefits. On the one hand, he receives the information how much volume is in the silo and how the distribution of the bulk material in the silo looks like. Secondly, the history data of the movement of the bulk material in the different areas (caused by filling and emptying) can be evaluated individually and in relation to each other. Artificial intelligence can be used for this purpose. This ensures the efficient use of the silo and also the detection of certain conditions in the silo. In particular, effects such as bridging, arching, funneling or rat holing can be detected and/or predicted.

FIG. 2 shows a measuring system for monitoring the surface topology of a bulk material according to one embodiment. The measuring system comprises a level measuring device 100 and an external control and evaluation unit 106, both of which may be designed for communication by means of a wired interface (for example, two-wire interface) and/or wireless communication, for example, by means of Bluetooth or APL.

In particular, the level measuring device 100 has a sensor unit 101 and an evaluation unit 102, as well as a communication unit 105.

The level measuring device can also be self-sufficient and powered by a battery. In this case, the data can be transmitted via a mobile communication channel, such as LoRa, for example, where the reduced amount of data is also helpful.

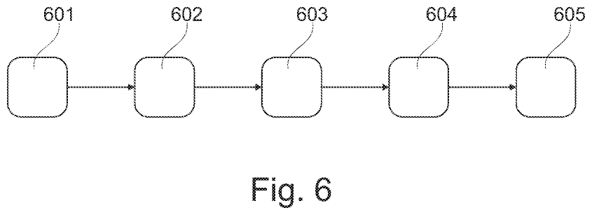

FIG. 6 shows a flow diagram of a method according to one embodiment. In step 601, a first area of the surface of the bulk material is scanned. In step 602, a second area of the surface of the bulk material is scanned. In step 603, the volume and/or average fill height of the bulk material below the first region is calculated, and in step 604, the volume and/or average fill height of the bulk material below the second region is calculated. In step 605, the calculation variables (volumes/fill heights) are transmitted to an external control and evaluation unit, which can then visualize the transmitted data.

In particular, the information to be transmitted can be reduced to the essential silo areas. These are, for example, areas in which a change has taken place. The division of the areas can depend on the geometry of the silo and on the customer requirements, such as size, shape, inlets, and outlets.

The geometry of the segments is basically selectable. Communication can take place via a simple data channel, such as HART, or, alternatively, via a wireless interface. From the history data, the silo utilization can be monitored and optimized. For example, it can be determined whether a particularly large amount of bulk material is being removed via an outlet of the silo. It can also be determined if an outlet is clogged, for example, because the level measuring device determines that the volume in the area associated with the outlet never goes below a certain amount.

By evaluating the history data of the areas individually and in combination with other areas, buildup can be detected, tunneling can be detected, one-sided loading can be detected, and dead zones can be detected.

It should be noted that “comprising” and “having” do not exclude other elements or steps, and the indefinite articles “a” or “an” do not exclude a plurality. It should further be noted that features or steps that have been described with reference to any of the above embodiments may also be used in combination with other features or steps of other embodiments described above. Reference signs in the claims are not to be regarded as limitations.

What is Claimed is:

1. A level measuring device configured to monitor the surface topology of a bulk material or liquid, comprising:
a sensor unit configured to scan a first area of the surface of the bulk material and a second area of the surface of the bulk material; and
an evaluation unit configured to calculate a first volume and/or a first mass and/or a first average filling height of the bulk material located below the first area of the surface of the bulk material, and a second volume and/or a second mass and/or a second average filling height of the bulk material located below the second area of the surface of the bulk material.

2. The level measuring device according to claim 1, wherein the sensor unit is configured to scan the first area with a first resolution and to scan the second area with a second resolution that is lower than the first resolution.

3. The level measuring device according to claim 1, wherein the first area has a different size than the second area.

4. The level measuring device according to claim 1, wherein the first area has a different shape than the second area.

5. The level measuring device according to claim 1, further comprising:
a communication unit configured to transmit the calculated volumes or fill levels to an external control and evaluation unit.

6. The level measuring device according to claim 5, wherein the communication unit is configured to transmit only a subset of the calculated volumes or fill levels during a data transmission to the external control and evaluation unit.

7. The level measuring device according to claim 5, wherein the communication unit is configured to transmit a calculated volume or a calculated filling level to the external control and evaluation unit only if it has changed compared to the previous calculation.

8. The level measuring device according to claim 1, wherein the level measuring device is configured to connect to a 4-20 mA two-wire interface or for radio transmission of the calculated volumes or fill levels.

9. The level measuring device according to claim 1, wherein the position of the first area is above an outlet or below an inlet of a container in which the bulk material is stored.

10. An external control and evaluation unit for the level measuring device according to claim 1,
wherein the external control and evaluation unit is configured to visualize the volumes or levels transmitted by the level meter.

11. A method for monitoring the surface topology of a bulk material, the method comprising:
scanning a first region of the surface of the bulk material and a second region of the surface of the bulk material; and
calculating a first volume and/or a first mass and/or a first average fill height of the bulk material located below the first area of the surface of the bulk material, and a second volume and/or a second mass and/or a second average fill height of the bulk material located below the second area of the surface of the bulk material.

12. The method according to claim 11, further comprising:
transferring the calculated volumes or fill levels to an external control and evaluation unit.

13. The method according to claim 11, further comprising:
visualizing the volumes or levels transmitted by the level meter.

14. A program element that, when executed on a system for monitoring the surface topology of a bulk material, directs the system to perform the method of claim 11.

15. A computer-readable medium on which is stored the program element according to claim 14.
